(19) United States
(12) Patent Application Publication
(10) Pub. No.: US 2018/0236765 A1
(43) Pub. Date: Aug. 23, 2018

(54) FLUID DEVICE

(71) Applicant: HEWLETT-PACKARD DEVELOPMENT COMPANY, L.P., Houston, TX (US)

(72) Inventors: Manish Giri, Corvallis, OR (US); Sadiq Bengali, Corvallis, OR (US)

(21) Appl. No.: 15/749,067

(22) PCT Filed: Jan. 25, 2016
(86) PCT No.: PCT/US2016/014743

§ 371 Date: Jan. 30, 2018

(51) Int. Cl. B41J 2/14; B41J 2/16

(52) U.S. Cl. CPC B41J 2/14153; B41J 2/14129; B41J 2/1601; B41J 2/1642; B41J 2/1629; B41J 2/1631; B41J 2/1628

(57) ABSTRACT

A device including a substrate and a channel formed in a layer disposed on the substrate. The layer includes a cavitation layer and a passivation layer to mitigate the effects of hydrodynamic cavitation on a surface of the channel. The passivation and cavitation material and thickness are optimized thermally to nucleate and eject a bubble at low voltages. A resistive heating element is disposed within the channel that is activated to create a micro-fluidic pump to advance a fluid through the channel. A sensor is disposed within the channel to measure a characteristic of the fluid passing through the channel.

### BACKGROUND

Various different sensing devices are currently available for sensing different attributes of fluid. The push for mobility has introduced portable sensing devices that are useful in remote environments. However, challenges arise in adapting such devices to operate on battery power as well as scaling the device to fit in a smaller housing. Such sensing devices often involve external pumps, are relatively large, complex, expensive, and lack precision and reliability.

### BRIEF DESCRIPTION OF THE DRAWINGS

FIG. 1 illustrates an example of a micro-fluidic sensor.

FIG. 2 illustrates a cross sectional view of the micro-fluidic sensor of FIG. 1.

FIG. 3 illustrates a cross sectional view of the micro-fluidic sensor of FIG. 2.

FIG. 4 illustrates another cross sectional view of the micro-fluidic sensor of FIG. 2.

FIG. 5 illustrates an example method that can be employed to manufacture a micro-fluidic sensor.

### DETAILED DESCRIPTION

This disclosure relates to a micro-fluidic sensor device and methods to fabricate a micro-fluidic sensor device. As an example, the micro-fluidic sensor device can include a substrate and at least one layer disposed on the substrate. A micro-channel can extend through (e.g., partially or completely) the substrate and/or the additional layers. In one example, a resistor (e.g., a resistive heating element) is arranged adjacent to an evacuation port of the micro-channel. When the resistor is activated, a micro-fluidic pump results, propelling a fluid to be measured from an injection port, through the micro-channel, and out via the evacuation port. At least one sensor is arranged within the micro-channel, for example, between the injection port and the resistor. Thus, as the pump advances the fluid past the sensor (e.g., two sensors), the device measures a characteristic of the fluid in response to the sensors. Based on the measured characteristic (e.g., impedance, capacitance, resistance), at least one feature of the fluid can be determined.

Thus, the micro-fluidic sensor device described herein provides a micro-electrical mechanical system (MEMS) suitable for operation at a low power (e.g., about 1-15 V). Accordingly, the materials selected for the micro-fluidic sensor device and dimensions thereof are well suited for forming a low power MEMS sensor. However, advancing fluid through an intricate micro-channel of a MEMS device subjects the surfaces exposed to the fluid to various effects. For example, a phenomenon called hydrodynamic cavitation can be produced by a liquid flowing through the constricted micro-channel. Hydrodynamic cavitation is a process of vaporization, bubble generation and bubble implosion which occurs in response to rapid, periodic decreases and increases in the fluid pressure. The combination of pressure and kinetic energy can create the hydrodynamic cavitation effect downstream of the constricted area of the micro-channel generating high energy cavitation bubbles that can cause damage to exposed surfaces. As the materials are selected for low power operation, with dimensions sufficiently small such that the entire sensor can be contained in a micronized cassette, hydrodynamic cavitation can cause damage to the sensor device and constituent components.

To mitigate damaging effect that fluid flow may introduce to the device, a thin, conformal passivation layer is incorporated (e.g., about 500 to about 1500 Å of Silicon Carbide, SiC) as well as a cavitation layer (e.g., about 500 to about 2500 Å of Tantalum, Ta). The layers are selected for properties that make them less affected by the effects of hydrodynamic cavitation than other surfaces. As a technique, passivation is the use of a light coat of a protective material, such as a dielectric, to create a shell against corrosion. In other words, passivation involves applying a coating of base material, for example, applying a passivation layer of SiC over an underlying oxide layer, and a cavitation layer of Ta over the SiC layer. In other words, both the passivation layer and the cavitation layer include particular materials with particular thicknesses that are selected to be optimized thermally to nucleate and eject a bubble from the fluid at low voltages within the micro-fluidic sensor.

The result is a micro-fluidic sensor device which can be contained in a small cassette (e.g., a few centimeters in area), with power demands that allow operation from a portable computing platform with limited power capacity (e.g., a tablet computer, smartphone, etc.). Further, by connection to such a computing platform, the micro-fluidic sensor device can be activated by the portable device, and the results of such an operation can be measured, and the data therefrom can be processed further (e.g., by a dedicated application, transmitted to a networked system for analysis and/or storage, etc.).

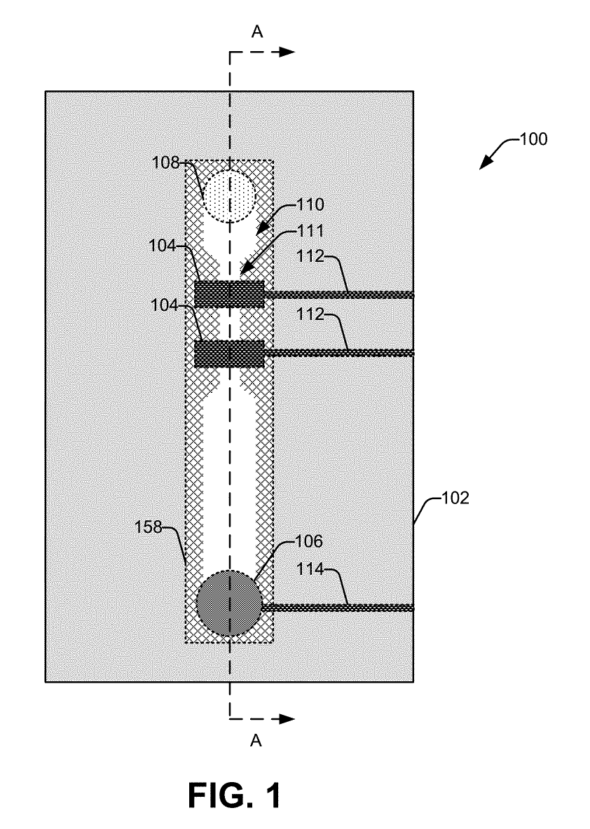

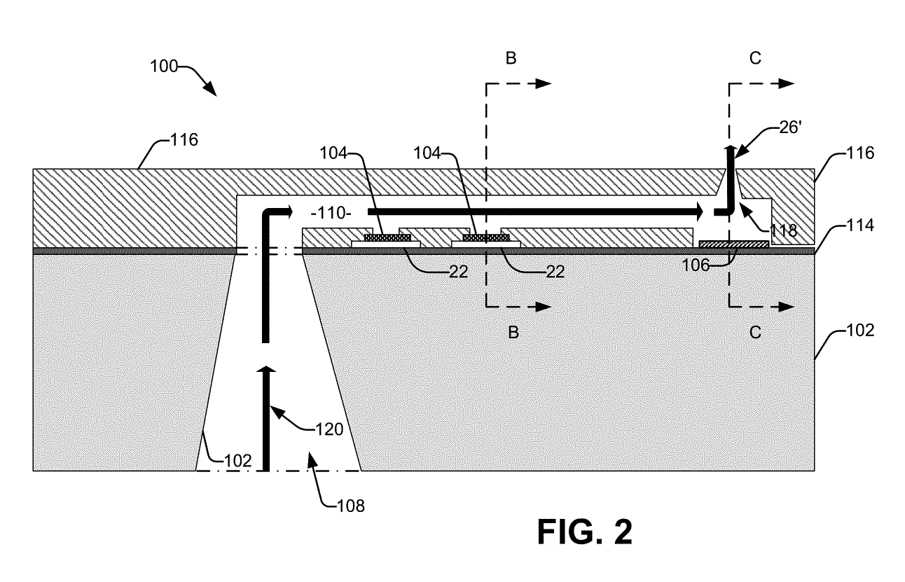

FIG. 1 illustrates an example micro-fluidic sensor device 100. The device 100 is shown from a top cross-section view without the top layers of the device 100, such that internal features of the device are shown. Different perspective views of the device 100 are provided in FIGS. 2-4. As shown in FIG. 1, the device 100 is mounted on a substrate 102 of a material suitable for manufacture of MEMS devices (e.g., Silicon, Si). A micro-channel 110 is formed above the substrate (e.g., in at least one of the top layers; see FIG. 2). The micro-channel 110 can be defined by a narrow constriction area 111 of the micro-channel 110 to focus the fluid as it flows past the sensor 104. At one end of the micro-channel 110 is an injection port 108. At the opposite end of the micro-channel 110 spaced apart from the injection port 108 disposed on the substrate 102 is a resistive heating element 106 arranged at the base of an ejection port. The resistive heating element 106 is, for example, a resistive heater with a substantially rectangular shape connected to a controller (not shown) by trace 114.

A sensor 104 is mounted on the substrate 102 within the micro-channel 110 and between injection port 108 and resistive heating element 106. For example, sensor 104 can be two sensors electrically isolated from each other and connected to a controller by at least one trace 112. In the example where two sensors 104 are employed, one sensor 104 can be connected to a voltage source and the other to ground, thereby creating a potential between the two sensors when activated. The sensor 104 can be made from a conductive material such as gold, which is inert and useful for sensing biological samples. Gold sensors can have dimensions of about 1 to 10 μm wide on the substrate, and a thickness of about 2000 to about 3000 Å (e.g., about 2500 Å). Such dimensions provide very low resistance which allows the device 100 to operate on a low voltage system (e.g., about 5 to about 10 V).

The device 100 can be connected to at least one fluid reservoir. For example, a reservoir can be connected to the injection port 108 and filled with a fluid to be tested. Another reservoir can be connected to the ejection port to collect fluid that flows from the reservoir, through the micro-channel 110, and out of the device 100. Activation of the resistive heating element 106 can advance fluid through the micro-channel 110 by creating a micro-fluidic pump. In one implementation, resistive heating element 106 comprises a thermal resistor, wherein pulses of electrical current passing through the thermal resistor causes resistive heating element 106 to produce heat, heating adjacent fluid to a temperature above a nucleation energy of the adjacent fluid to create a vapor bubble which forcefully expels fluid through ejection port 118 into a discharge reservoir. Upon ejection of the bubble, negative pressure draws fluid through injection port 108 into micro-channel 110 and across sensor 104 to occupy the prior volume of the collapsed bubble. Moreover, as the fluid flows through the micro-channel, a potential can be applied to the sensor 104 to measure an electrical response thereto (e.g., impedance, capacitance, resistance). Based on the measured characteristic, at least one attribute of the fluid can be determined.

FIG. 2 illustrates a cross-sectioned view of the micro-fluidic sensor device 100 taken along the line A-A, as shown in FIG. 1. Substrate 102 is shown with ingress port 108 extending there through. The ingress port 108 can be formed by a suitable etching technique (e.g., dry etch, wet etch, etc.). At least one layer 114 can be deposited on a surface of the substrate 102. For example, the at least one layer 114 can include at least one dielectric layer (e.g., a passivation layer), at least one metallic layer (e.g., a cavitation layer), as well as structural layers to arrange the sensor 104 and the resistive heating element 106. Additionally, an encapsulation layer 116 (e.g., an epoxy based material) is deposited over the layers 114 to encapsulate the device 100. Further, the micro-channel 110 is formed within encapsulation layer 116, exposing each of the sensor 104 and the resistive heating element 106 to the fluid 120 flowing there through. Specifically, an ejection port 118 is formed through the encapsulation layer 116 such that the resistive heating element 106 is arranged to influence (e.g., heat) the fluid 120 to increase the pressure thereof, forcing fluid 120′ to be ejected through the ejection port 118. The activation of the resistive heating element 106 thus creates a micro-fluidic pump, which advances the fluid into the injection port 108, through micro-channel 110, and out through ejection port 118.

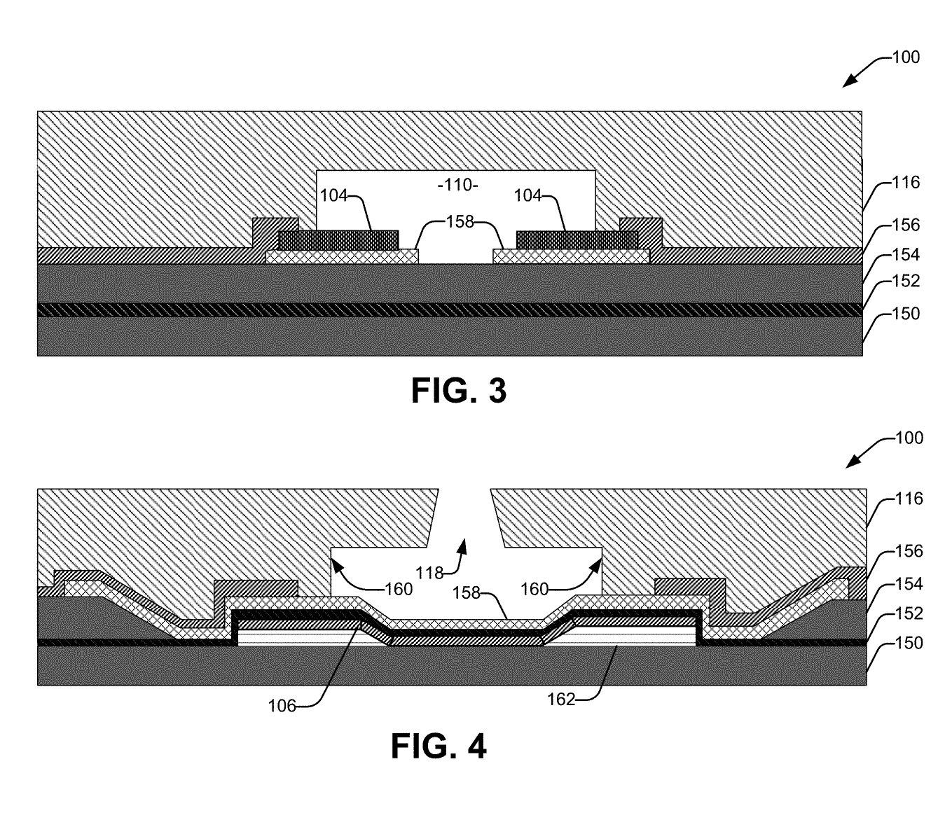

However, as explained above, the changes in pressure of the moving fluid subjects the surfaces of the device 100 to damaging effects, such as from cavitation. Thus, as shown in FIGS. 3 and 4, material layer 114 includes several distinct layers having useful dimensions to ensure proper operation of a low voltage, micro-fluidic sensor device. Further, FIGS. 3 and 4 illustrate examples of the areas of the device 100 that represent the sensor 104 and the resistive heating element 106, respectively. Although shown separately for reasons of clarity, it is noted that the two areas are formed on a single surface of the substrate 102, and layers common to both areas may be formed in a single process, in multiple processes, serially or in different orders of operation, as is best suited for the manufacturing environment and desired structure of the device 100. For example, thermal oxidation and/or chemical vapor deposition or the like can be employed to fabricate at least one layer that make up device 100. Fabrication can, for example, be performed by applying appropriate deposition, patterning and/or etching techniques to a stack of materials, although the examples described are not limited to these techniques. Such devices can have a complicated structure, which may be formed from a number of thin layers with various compositions. Fabrication can, for example, include utilizing photolithography (e.g., UV i-Line lithography) to pattern and etch predetermined variations in the structure.

Thus, FIG. 3 illustrates a cross-section view of FIG. 2 taken along the line B-B with a focus on the sensor 104. A passivation layer 152 is deposited between a first dielectric layer 150 (e.g., planarized Tetraethyl orthosilicate oxide, i.e. TEOS oxide) and a second dielectric layer 154 (e.g., planarized TEOS oxide). A cavitation layer 158 is deposited in a region exposed to the micro-channel 110, with sensor(s) 104 deposited thereon. Additionally, a die surface optimization (DSO) layer 156 is formed on the surface of the second dielectric layer 154 that is not in contact with the cavitation layer 158. Further, encapsulation layer 116 (e.g., an epoxy) is deposited above DSO layer 156, with micro-channel 110 formed within.

FIG. 4 illustrates a cross-sectioned view of FIG. 2 taken along the line C-C. Thus, FIG. 4 provides a cross-section view of the resistive heating element 106 disposed adjacent to the ejection port 118. A metallic layer 162 (e.g., aluminum, or Al/Cu) with a thickness of about 3000 Å to about 6000 Å (e.g., about 5000 Å) is deposited over the first dielectric layer 150 at a region of the first dielectric layer 150 that coincides with at least one sidewall 160 of the micro-channel 110, and can be modified by an end pointed etching process. The metallic layer 162 is deposited such that a central region of the first dielectric layer 150 remains exposed. The resistive heating element 106 (e.g., comprising Ta) of about 500 to about 1500 Å (e.g., about 1000 Å) thick is deposited on the surface of the metallic layer 162 as well as the central region of the first dielectric layer 150 not covered by the metallic layer 162. The passivation layer 152 is then formed over the exposed regions of the first dielectric layer 150 and the resistive heating element 106. The second dielectric layer 154 is formed overlying the passivation layer 152 extending from external edge of the device 100 and sloping downwards toward the resistive heating element 106.

The cavitation layer 158 is deposited overlying the exposed portion of the passivation layer 152 as well as regions of the second dielectric layer 154. However, the cavitation layer 158 falls short of the external edge of device 100. Thus, DSO layer 156 is deposited on the surface of the cavitation layer 158, extending from external edges of the device 100 but not to extend into the cavity 110. Further, encapsulation layer 116 is deposited overlying DSO layer 156, with micro-channel 110 to be formed within, leaving only a surface of resistive heating element 106 exposed to the micro-channel 110. The micro-channel 110 can be formed in the encapsulation layer 116 by various methods, such as coating, deposition, lithography, etching, etc. In forming the micro-channel 110, the ejection port 118 is formed adjacent to resistive heating element 106 through the encapsulating layer 116.

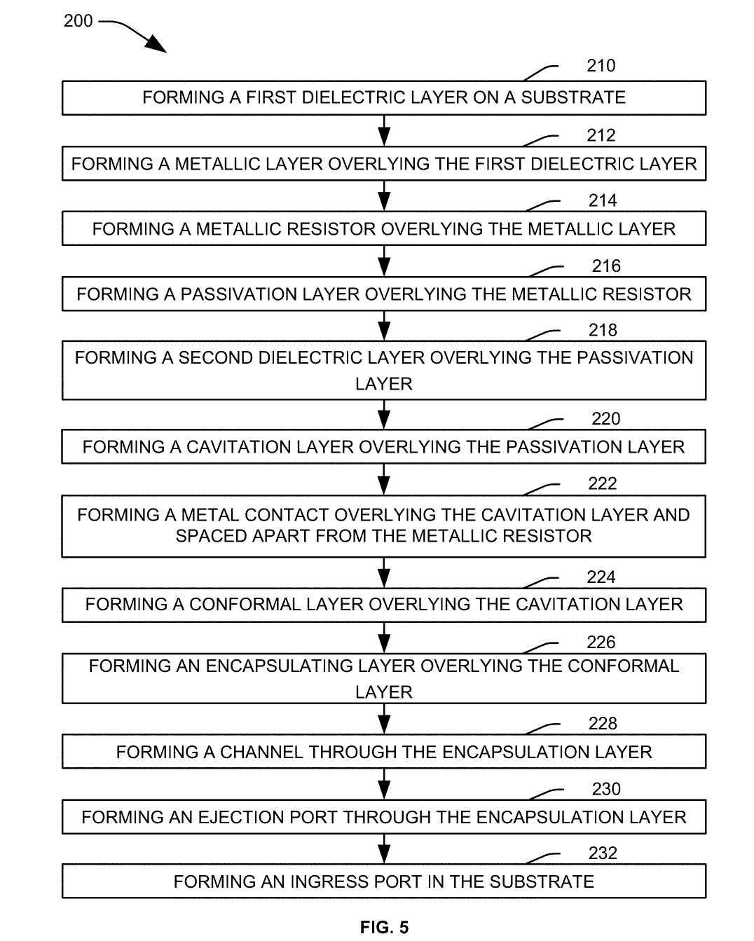

In view of the foregoing structural and functional features described above, example methods of making a micro-fluidic sensor device (e.g., the device 100 of FIG. 1) will be better appreciated with reference to FIG. 5. In the examples of FIG. 5, various types of process parameters can be utilized at various stages according to application requirements and the structures being fabricated and materials used in such fabrication. While, for purposes of simplicity of explanation, the method of FIG. 5 is shown and described as executing serially, the methods are not limited by the illustrated order, as some actions could in other examples occur in different orders and/or concurrently from that shown and described herein.

The method described in FIG. 5 is provided as a flow chart 200 outlining the processes involved to make a micro-fluidic device, such as the device 100 illustrated in FIGS. 1-4. At 210, a first dielectric layer is formed on a surface of a substrate (e.g., made of Si). In forming the portion of the device associated with the resistive heating element 106, a metallic layer (e.g., comprising at least one of about 25 to about 100 Å (e.g., about 50 Å) of titanium, Ti, about 250 to about 500 Å (e.g., about 375 Å) of titanium nitride, TiN, and about 3500 to about 7500 Å (e.g., about 5200 Å) of aluminum copper, AlCu) is deposited and processed overlying the first dielectric layer at 212. At 214, a metallic resistor having a thickness of about 500 to about 1500 Å (e.g., about 1000 Å) of Ta is deposited over the metallic layer, and processed accordingly. At 216, a passivation layer having a thickness of about 500 to about 1500 Å (e.g., about 1000 Å) of conformal SiC is formed overlying the resistor and exposed regions of the first dielectric layer. At 218, a second dielectric layer is deposited and processed overlying the passivation layer. At 220, a cavitation layer having a thickness of about 500 to about 2500 Å (e.g., about 2000 Å) of Ta is then formed over the passivation layer. In forming an interconnect layer in 222, a, metal layer having a thickness of about 1500 to about 3000 Å (e.g., about 2500 Å) of Au is deposited and patterned, spaced apart from the metallic resistor. At 224, a conformal layer having a thickness of about 500 to about 2500 Å (e.g., about 1500 Å) of SiC is then deposited and processed over the cavitation layer and the metal contacts. At 226, an encapsulating layer (e.g., formed of an epoxy) is formed overlying the conformal layer and exposed portions of the metal contacts and the metallic resistor.

Through the encapsulation layer, a micro-channel can be formed at 228, for example by photolithography or other suitable techniques. The micro-channel can be formed to have a smooth or textured surface and may include planar surfaces or the surfaces, in other examples, could be curved. Further, the micro-channel may be formed such that the cross-sectional area of the micro-channel is smaller at the sensor than at other sections in order to focus fluid as it flows past the sensors. Moreover, the micro-channel can be formed as straight curved, or another suitable form. The micro-channel can be wholly contained within the encapsulation layer, with an ejection port formed through a surface of the encapsulation layer opposite the substrate and adjacent the heating element at 230. Additionally or alternatively, another layer (e.g., the substrate) can be processed to contain a portion of the micro-channel. At 232, an ingress port is also formed in the substrate to extend into the micro-channel, resulting in an unimpeded pathway from, for example, an external reservoir at the ingress port, through the ingress port and through the micro-channel, out through the ejection port and into, for example, another reservoir.

The resulting structure, for example as shown in FIGS. 1-4, is a thermally efficient, low power sensing device. The use of inert gold sensor contacts ensures that the composition of the fluid will not adversely affect the surfaces and negatively impact the sensor's capability to operate efficiently. Moreover, in order to maintain a functional device within a micro-cassette, thin passivation and cavitation layers are employed. Specifically, a conformal passivation layer, on the order of about 1000 Å, and a metallic cavitation layer, on the order of about 2000 Å, ensures the micro-fluidic sensor device described herein is functional, efficient, and robust.

Furthermore, relative terms used to describe the structural features of the figures illustrated herein, such as above and below, up and down, first and second, near and far, etc., are in no way limiting to conceivable implementations. For instance, where examples of the structure described herein are described in terms consistent with the figures being described, and actual structures can be viewed from a different perspective, such that above and below may be inverted, e.g., below and above, or placed on a side, e.g., left and right, etc. Such alternatives are fully embraced and explained by the figures and description provided herein.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include at least one such element, neither requiring nor excluding two or more such elements. As used herein, the term “includes” means includes but not limited to, and the term “including” means including but not limited to. The term “based on” means based at least in part on. The term “about” describes a range of possible values. Thus, a level of tolerance is expected between devices, for example, due to various manufacturing techniques and outcomes.

What is claimed is:

1. A device comprising:
a substrate;
a channel formed in a plurality of layers disposed on the substrate, wherein the plurality of layers are selected to have a thickness for operation at a low-voltage, the plurality of layers including a passivation layer and a cavitation layer to mitigate the effects of hydrodynamic cavitation on a surface of the channel;
a resistive heating element disposed within the channel, the resistive heating element being activated to create a micro-fluidic pump to advance a fluid through the channel; and
a sensor disposed within the channel to measure a characteristic of the fluid passing through the channel.

2. The device of claim 1 wherein the cavitation layer has a thickness of about 500 Å to about 2500 Å.

3. The device of claim 1 wherein the passivation layer has a thickness of about 500 Å to about 1500 Å.

4. The device of claim 1 wherein the resistive heating element has a thickness of about 500 Å to about 1500 Å.

5. The device of claim 1 wherein the resistive heating element comprises tantalum.

6. The device of claim 1 wherein the sensor has a thickness of about 1500 Å to about 3000 Å.

7. The device of claim 1 wherein the sensor is to measure one of an impedance, a capacitance, and a resistance associated with the fluid.

8. The device of claim 1 wherein a material and the thickness of each of the passivation layer and the cavitation layer are selected to be thermally optimized to nucleate and eject a bubble from the fluid at low voltages.

9. A micro-fluidic sensor device comprising:
a substrate;
a plurality of thin film layers on a first surface of the substrate, at least two of the layers forming a passivation layer and a cavitation layer;
a resistive heater on the substrate adjacent the ejection port; and
at least one channel in an encapsulation layer, the at least one channel providing a pathway from an injection port through the substrate, and to an ejection port formed in the encapsulation layer.

10. The micro-fluidic sensor device of claim 9 further comprising a sensor comprising gold.

11. The micro-fluidic sensor device of claim 9 further comprising at least one additional sensor.

12. The micro-fluidic sensor device of claim 9 wherein the fluid is blood.

13. A method of forming a device comprising:
forming a plurality of thin film layers on a first surface of a substrate, the plurality of thin film layers comprising a passivation layer and a cavitation layer;
forming a resistive heater on the substrate adjacent an ejection port formed in the encapsulation layer; and
forming at least one channel in an encapsulation layer, the at least one channel providing a pathway from an injection port through the substrate, through the channel, and through the ejection port.

14. The method of claim 13 wherein the cavitation layer has a thickness of about 500 Å to about 2500 Å, and the passivation layer has a thickness of about 500 Å to about 1500 Å.

15. The method of claim 13 wherein the ejection port resides adjacent to the resistive heater.
